(19) United States
(12) Patent Application Publication
(10) Pub. No.: US 2024/0073008 A1
(43) Pub. Date: Feb. 29, 2024

(54) SECURE COMPUTATION SYSTEM, SECURE COMPUTATION SERVER APPARATUS, SECURE COMPUTATION METHOD, AND SECURE COMPUTATION PROGRAM

(71) Applicant: NEC CORPORATION, Minato-ku, Tokyo (JP)

(72) Inventor: Hikaru Tsuchida, Tokyo (JP)

(73) Assignee: NEC CORPORATION, Minato-ku, Tokyo (JP)

(21) Appl. No.: 18/271,802

(22) PCT Filed: Jan. 12, 2021
(86) PCT No.: PCT/JP2021/000661

§ 371 Date: Jul. 11, 2023

(51) Int. Cl. H04L 9/08; H04L 9/40

(52) U.S. Cl. CPC H04L 9/085; H04L 63/0869

(57) ABSTRACT

An individual one of secure computation server apparatuses in a secure computation system includes: a local reshare part that computes an arithmetic share from a logic share without communicating with the other secure computation server apparatuses by setting a sub-share not held thereby to zero; a secure computation part that performs a secure computation with communications by using the arithmetic share acquired by the local reshare part, to acquire an arithmetic share from the logic share through a bit conversion; and a comparison and verification part that compares received values with each other, which are received from at least three of the secure computation server apparatuses and which are supposed to be a same value, and adopts the received values that are same at least two received values as an accurate value. The comparison and verification part verifies the received values acquired in the secure computation with communications.

### TECHNICAL FIELD

The present invention relates to a secure computation system, a secure computation server apparatus, a secure computation method, and a secure computation program.

### BACKGROUND ART

In recent years, researches and developments on techniques referred to as secure computation are active. Secure computation is one of the techniques for executing predetermined processing while keeping its computation processes and the results thereof secret to third parties. One typical technique used for secure computation is a multiparty computation technique. In this multiparty computation technique, data that needs to be kept secret is distributed to a plurality of servers (secure computation server apparatuses), and each server performs various operations on the data distributed thereto while keeping the data secret. The data distributed to the individual secure computation server apparatuses is called “shares”. Hereinafter, unless otherwise stated, the term “secure computation” signifies the multiparty computation technique.

In the secure computation as described above, computation protocols for specific use are usually implemented in addition to four basic arithmetic operations. One example of these computation protocols for specific use is a bit conversion protocol. “Bit conversion” is a type conversion associated with a modulus conversion, an example of which is a conversion for acquiring shares on a residue class ring Zn of modulo n from shares on a residue class ring Z₂ of modulo 2. For example, this bit conversion can improve the computation efficiency of a mixed circuit performing an arithmetic operation and a logical operation.

A simple example performed by the mixed circuit performing an arithmetic operation and a logical operation is computation of a Hamming distance. The Hamming distance represents the number of different digits when two binary numbers are compared with each other. For example, the Hamming distance between 1111111 and 1010101 is 3. When the Hamming distance is computed, whether digits differ from each other is determined by an exclusive-or, and therefore, it is preferable that a logical operation be performed for this determination. In addition, it is preferable that the number of different digits be determined by an arithmetic operation. The secure computation including the bit conversion protocol can compute these secure computation processes in the mixed circuit performing an arithmetic operation and a logical operation with suitable modulo for their respective operations. Thus, the secure computation including the bit conversion protocol can improve the computation efficiency.

### CITATION LIST

### Non-Patent Literature

NPL 1: Byali, M., Chaudhari, H., Patra, A., & Suresh, A. (2020). FLASH: fast and robust framework for privacy-preserving machine learning. Proceedings on Privacy Enhancing Technologies, 2020(2), 459-480.

### SUMMARY

### Technical Problem

The disclosure of the above citation list is incorporated herein in its entirety by reference thereto. The following analysis has been made by the present inventor.

Different techniques that are generally referred to as secure computation achieve different security levels. For example, a case in which one of the participants in a multiparty secure computation is a dishonest person will be considered. In this case, it is possible to adopt a secure computation technique that can detect the presence of the dishonest person and can abort its processes. Alternatively, it is possible to adopt a secure computation technique that can obtain an accurate computation result without aborting its processes even if there is the dishonest person. The latter technique achieves a higher security than the former technique. The secure computation satisfying the latter security is referred to as Guaranteed Output Delivery (GOD), and an example of the secure computation realizing this GOD is known (for example, see NPL 1).

In addition, regarding the evaluation of the security in the secure computation, not only the advantageous effects of the security that can be achieved, but also pre-conditions have significant implications. A typical pre-condition is use of a random oracle model as a hash function.

A hash function is a function that responds a unique output to an input, and it is difficult to deduce the input from the output. However, although it is difficult to deduce the input from the output, there is no guarantee that the input cannot be deduced from the output. Thus, the security is evaluated on the assumption that the hash function used does not have vulnerability. The security based on this assumption is called “as being secure in the random oracle model”. The security of the secure computation in NPL 1 is “as being secure in the random oracle model”.

In contrast, there is an expression “as being secure in the standard model”, as opposed to “as being secure in the random oracle model”. That is, although the input could be deduced from the output of the hash function, if this itself does not mean vulnerability of the secure computation, the security is referred to “as being secure in the standard model”. Of course, if the same security level is achieved, the security of the standard model is higher than the security of the random oracle model. Thus, when the bit conversion protocol is used, too, it is desirable to achieve Guaranteed Output Delivery (GOD) in the standard model.

The present invention has been made in view of the above problem, and it is an object of the present invention to provide a secure computation system, a secure computation server apparatus, a secure computation method, and a secure computation program that contribute to a bit conversion that achieves Guaranteed Output Delivery (GOD) in the standard model.

### Solution to Problem

According to a first aspect of the present invention, there is provided a secure computation system, which includes five secure computation server apparatuses connected to each other via a network and which performs a bit conversion from logic shares on a residue class ring of modulo 2 that are held in a secret sharing manner to arithmetic shares on a residue class ring of modulo n (n=2^{m}; m is an integer of 2 or more), an individual one of the secure computation server apparatuses including: a local reshare part that computes an arithmetic share from the logic shares without communicating with the other secure computation server apparatuses by setting a sub-share not held by its host secure computation server apparatus to zero; a secure computation part that performs a secure computation with communications by using the arithmetic share acquired by the local reshare part, to acquire an arithmetic share from the logic share through a bit conversion; and a comparison and verification part that compares received values with each other, which are received from at least three of the secure computation server apparatuses and which are supposed to be a same value, and adopts the received values that are same at least two received values as an accurate value; wherein the comparison and verification part verifies the received values acquired in the secure computation with communications.

According to a second aspect of the present invention, there is provided a secure computation server apparatus, which is one of at least five secure computation server apparatuses connected to each other via a network for performing a bit conversion from logic shares on a residue class ring of modulo 2 that are held in a secret sharing manner to arithmetic shares on a residue class ring of modulo n (n=2^{m}; m is an integer of 2 or more), the secure computation server apparatus including: a local reshare part that computes an arithmetic share from the logic shares without communicating with the other secure computation server apparatuses by setting a sub-share not held by its host secure computation server apparatus to zero; a secure computation part that performs a secure computation with communications by using the arithmetic share acquired by the local reshare part, to acquire an arithmetic share from the logic share through a bit conversion; and a comparison and verification part that compares received values with each other, which are received from at least three of the secure computation server apparatuses and which are supposed to be a same value, and adopts the received values that are same at least two received values as an accurate value; wherein the comparison and verification part verifies the received values acquired in the secure computation with communications.

According to a third aspect of the present invention, there is provided a secure computation method, for performing a bit conversion from logic shares on a residue class ring of modulo 2 that are held in a secret sharing manner to arithmetic shares on a residue class ring of modulo n (n=2^{m}; m is an integer of 2 or more) by using five secure computation server apparatuses connected to each other via a network, the secure computation method including: causing an individual one of the secure computation server apparatuses to perform reshare to an arithmetic share from the logic shares without communicating with the other secure computation server apparatuses by setting a sub-share not held thereby to zero; causing the individual one of the secure computation server apparatuses to perform a secure computation with communications by using the arithmetic share acquired by the reshare, to acquire an arithmetic share from the logic share through a bit conversion; and causing the individual one of the secure computation server apparatuses to compare received values with each other, which are received from at least three of the secure computation server apparatuses and which are supposed to be a same value, and adopt the received values that are same at least two received values as an accurate value, so as to verify the received values acquired in the secure computation with communications.

According to a fourth aspect of the present invention, there is provided a secure computation program, causing at least five secure computation server apparatuses connected to each other via a network to perform a secure computation on values held in a secret sharing manner and causing five secure computation server apparatuses connected to each other via a network to perform a bit conversion from logic shares on a residue class ring of modulo 2 that are held in a secret sharing manner to arithmetic shares on a residue class ring of modulo n (n=2^{m}; m is an integer of 2 or more), an individual one of the secure computation server apparatuses performing: resharing to an arithmetic share from the logic shares without communicating with the other secure computation server apparatuses by setting a sub-share not held thereby to zero; a secure computation with communications by using the arithmetic share acquired by the reshare, to acquire an arithmetic share from the logic share through a bit conversion; and comparing received values with each other, which are received from at least three of the secure computation server apparatuses and which are supposed to be a same value, and adopting the received values that are same at least two received values as an accurate value, so as to verify the received values acquired in the secure computation with communications. The program can be recorded in a computer-readable storage medium. The storage medium may be a non-transient storage medium such as a semiconductor memory, a hard disk, a magnetic recording medium, or an optical recording medium. The present invention can be embodied as a computer program product.

### Advantageous Effects of Invention

According to the individual aspects of the present invention, it is possible to provide a secure computation system, a secure computation server apparatus, a secure computation method, and a secure computation program that contribute to a bit conversion that achieves Guaranteed Output Delivery (GOD) in the standard model.

### BRIEF DESCRIPTION OF DRAWINGS

FIG. 1 is a block diagram illustrating a functional configuration example of a secure computation system according to a first example embodiment.

FIG. 2 is a block diagram illustrating a functional configuration example of a secure computation server apparatus according to the first example embodiment.

FIG. 3 is a flowchart illustrating an outline of a procedure of a secure computation method.

FIG. 4 is a block diagram illustrating a functional configuration example of a secure computation system according to a second example embodiment.

FIG. 5 is a block diagram illustrating a functional configuration example of a secure computation server apparatus according to the second example embodiment.

FIG. 6 is a block diagram illustrating a functional configuration example of a secure computation system according to a third example embodiment.

FIG. 7 is a block diagram illustrating a functional configuration example of a secure computation server apparatus according to the third example embodiment.

FIG. 8 is a flowchart illustrating an outline of a procedure of a secure computation method.

FIG. 9 is a diagram illustrating a hardware configuration example of a secure computation server apparatus.

### EXAMPLE EMBODIMENTS

Hereinafter, example embodiments of the present invention will be described with reference to the accompanying drawings. However, the present invention is not limited to the following example embodiments. In addition, in the drawings, the same or equivalent elements are denoted by the same reference characters, as necessary. In addition, the drawings are schematic drawings, and therefore, it should be noted that the sizes, ratios, etc. of the individual elements may differ from their actual sizes, ratios, etc. An element in a drawing may have a portion whose size or ratio differs from that of the portion of the element in a different drawing.

### [First Example Embodiment]

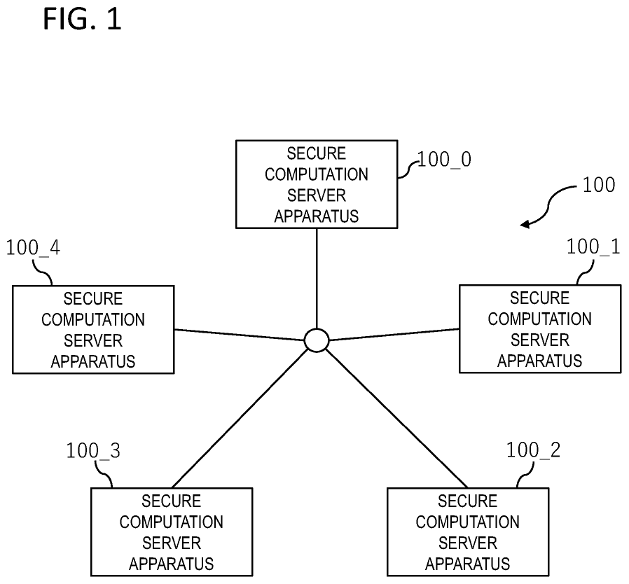

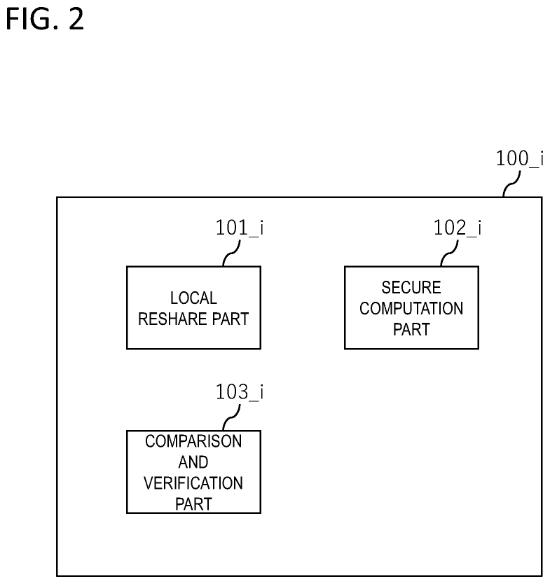

Hereinafter, a secure computation system and secure computation server apparatuses according to a first example embodiment will be described with reference to FIGS. 1 and 2. The first example embodiment is an example embodiment for describing only a basic concept of the present invention.

FIG. 1 is a block diagram illustrating a functional configuration example of a secure computation system according to the first example embodiment. As illustrated in FIG. 1, a secure computation system 100 according to the first example embodiment includes a first secure computation server apparatus 100_0, a second secure computation server apparatus 100_1, a third secure computation server apparatus 100_2, a fourth secure computation server apparatus 100_3, and a fifth secure computation server apparatus 100_4. The first secure computation server apparatus 100_0, the second secure computation server apparatus 100_1, the third secure computation server apparatus 100_2, the fourth secure computation server apparatus 100_3, and the fifth secure computation server apparatus 100_4 are connected to each other via a network such that these apparatuses can communicate with each other.

In the secure computation system 100 including the first to fifth secure computation server apparatuses 100_i (i=0, 1, 2, 3, 4), it is possible to compute target shares from a value inputted to any one of the first to fifth secure computation server apparatuses 100_i (i=0, 1, 2, 3, 4) while keeping the input value and the values acquired in the computation processes secret, and it is possible to dispersedly store the computation results in the first to fifth secure computation server apparatuses 100_i (i=0, 1, 2, 3, 4).

In addition, in the secure computation system 100 including the first to fifth secure computation server apparatuses 100_i (i=0, 1, 2, 3, 4), it is possible to compute target shares from the shares dispersedly stored in the first to fifth secure computation server apparatuses 100_i (i=0, 1, 2, 3, 4) while keeping the values in the computation processes secret, and it is possible to dispersedly store the computation results in the first to fifth secure computation server apparatuses 100_i (i=0, 1, 2, 3, 4).

The shares of the computation results may be reconstructed by causing the first to fifth secure computation server apparatuses 100_0 to 100_4 exchange their shares with each other. Alternatively, the shares may be decoded by transmitting the shares to an external apparatus other than the first to fifth secure computation server apparatuses 100_0 to 100_4.

In addition, in the secure computation system 100 including the first to fifth secure computation server apparatuses 100_i (i=0, 1, 2, 3, 4), even when one of the first to fifth secure computation server apparatuses 100_i (i=0, 1, 2, 3, 4) is operated by a dishonest person, it is possible to continue an accurate secure computation without stopping the processes.

For example, the following construction may be adopted as the construction of the shares that enables continuation of an accurate secure computation without stopping the processes even when one of the first to fifth secure computation server apparatuses 100_i (i=0, 1, 2, 3, 4) is operated by a dishonest person as described above.

Shares of an element x of a residue class ring Zₙ of modulo n, that is, x∈Zₙ, on the residue class ring Zₙ are defined as follows (the shares may be referred to as arithmetic shares, as necessary). Note that n=2^{m}, where m is an integer of 2 or more. That is, a residue class ring Z₂ of modulo 2 is distinguished from the residue class ring Zₙ of modulo n.

An element x of the residue class ring Zₙ of modulo n, that is, x∈Zₙ, is decomposed to satisfy the following relationship:

x=x₀+x₁+x₂+x₃+x₄ mod n

[x]ᵢ dispersedly held by the individual participants Pi (i=0, 1, 2, 3, 4) is defined as follows.

[x]ᵢ=(xᵢ,xᵢ₊₁,xᵢ₊₂,xᵢ₊₃), note that x₄₊₁=x₀

Shares of an element x of the residue class ring Z₂ of modulo 2, that is, x∈Z₂, on the residue class ring Z₂ (the shares may be referred to as logic shares, as necessary) are defined in the same way as the above shares on the residue class ring Zₙ where n=2. However, a different notation [x]^{B} is used to distinguish the residue class ring Z₂ of order 2 from the residue class ring Zₙ of modulo n. That is, the shares are specifically defined as follows.

An element x of the residue class ring Z₂ of modulo 2, that is, x∈Z₂, is decomposed as follows. In Equation 1, “+” inside a circle represents an exclusive-or.

x=x₀⊕x₁⊕x₂⊕x₃⊕x₄ mod 2 [Equation 1]

[x]^{B}ᵢ dispersedly held by the individual participants Pi (i=0, 1, 2, 3, 4) is defined as follows.

[x]^{B}ᵢ=(xᵢ,xᵢ₊₁,xᵢ₊₂,xᵢ₊₃), note that x₄₊₁=x₀

If these shares [x]₀, [x]₁, [x]₂, [x]₃, and [x]₄ held by the individual participants Pi (i=0, 1, 2, 3, 4) are determined as described above, the individual participants Pi (i=0, 1, 2, 3, 4) cannot reconstruct x from their shares [x]₀, [x]₁, [x]₂, [x]₃, and [x]₄ held thereby. However, it is possible to realize secret sharing in which x can be reconstructed if the shares held by at least two of the participants Pi (i=0, 1, 2, 3, 4) are combined. This secret sharing scheme is referred to as a 2-out-of-5 Replicated Secret Sharing Scheme.

In a secure computation based on this secret sharing scheme, not only when x is reconstructed but also when a bit conversion is performed, there is a situation in which the individual participants directly or indirectly receive the values of the sub-shares not held thereby from other participants.

For example, in the case of value 1, each of (1, 0, 0, 0, 0) and (1, 1, 1, 1, 1) is the result of decomposition of value 1 into an exclusive-or. However, although 1+0+0+0+0=1, 1+1+1+1+1=5. Thus, (1, 1, 1, 1, 1) is not the arithmetic sum of value 1. That is, although (1, 0, 0, 0, 0) and (1, 1, 1, 1, 1) represent the same value as shares of an element x of the residue class ring Z₂ of modulo 2, that is, x∈Z₂, on the residue class ring Z₂, (1, 0, 0, 0, 0) and (1,1, 1, 1, 1) do not represent the same value as shares of an element x of the residue class ring Zₙ of modulo n, that is, x∈Zₙ, on the residue class ring Zₙ.

Thus, when a bit conversion is performed, too, there is a situation in which an individual participant also directly or indirectly receives the value of a sub-share not held thereby from other participants. In this situation, if one of the other participants is a dishonest person, a participant could receive a different value instead of a value that the participant is originally supposed to receive. If this happens, the secure computation is performed based on an erroneous value, resulting in an erroneous computation. In some cases, the computation itself cannot be performed properly.

To solve this problem, in the secure computation system 100 according to the present example embodiment, as illustrated in FIG. 2, an individual one of the first to fifth secure computation server apparatuses 100_i (i=0, 1, 2, 3, 4) includes a local reshare part 101_i, a secure computation part 102_i, and a comparison and verification part 103_i. FIG. 2 is a block diagram illustrating a functional configuration example of a secure computation server apparatus according to the first example embodiment.

The local reshare part 101_i computes an arithmetic share without communicating with the other secure computation server apparatuses by setting a sub-share not held by its host secure computation server apparatus 100_i to zero from a logic share. The secure computation part 102 i performs a secure computation with communications by using the arithmetic share acquired by the local reshare part 101_i, to acquire an arithmetic share from the logic share through a bit conversion. The comparison and verification part 103_i compares received values with each other, which are received from at least three of the secure computation server apparatuses and which are supposed to be the same value, and adopts the received values that are same at least two received values as an accurate value. In this way, the comparison and verification part 103_i verifies the received values acquired in the secure computation with communications.

As described above, in the secure computation system 100 according to the present example embodiment, when the bit conversion is performed from logic shares on a residue class ring of modulo 2 to arithmetic shares on a residue class ring of modulo n, reshare (local reshare) is first performed without performing communications. Next, a secure computation with communications is performed to acquire an arithmetic share from the logic share through a bit conversion by using the arithmetic share on which the local reshare has been performed. Next, by comparing received values with each other, which are received in the secure computation with communications from at least three of the secure computation server apparatuses and which are supposed to be the same value, the received values are verified.

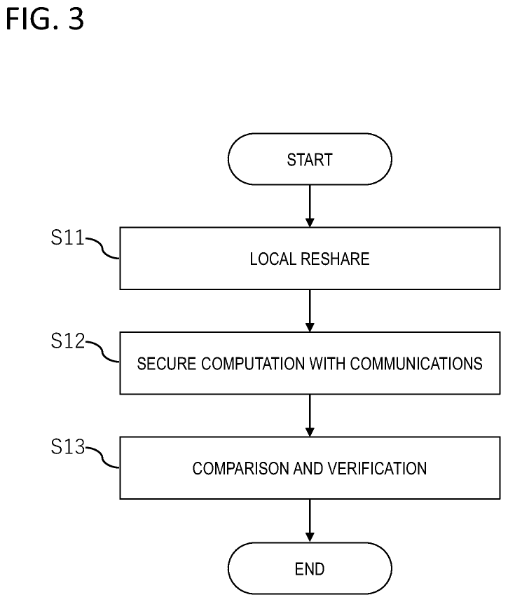

Next, a secure computation method according to the present example embodiment will be described. FIG. 3 is a flowchart illustrating an outline of a procedure of the secure computation method.

As illustrated in FIG. 3, the secure computation method according to the present example embodiment includes a local reshare step (S11), a secure computation step (S12) with communications, and a comparison and verification step (S13). In the local reshare step (S11), an individual secure computation server apparatus computes an arithmetic share without communicating with the other secure computation server apparatuses by setting a sub-share not held thereby to zero from a logic share. In the secure computation step (S12) with communications, to acquire an arithmetic share from the logic share through a bit conversion, the individual secure computation server apparatus performs a secure computation with communications by using the arithmetic share on which the local reshare has been performed. Next, in the comparison and verification step (S13), the individual secure computation server apparatus compares received values with each other, which are received from at least three of the secure computation server apparatuses and which are supposed to be the same value, and adopts the received values that are same at least two received values as an accurate value. In this way, the individual secure computation server apparatus verifies the received values acquired in the secure computation with communications. The comparison and verification step (S13) is performed each time the secure computation step (S12) with communications is performed.

As described above, in the secure computation system 100 and the secure computation method according to the present example embodiment, a participant receives received values, which are received from at least three of the other participants and which are supposed to be the same value, and adopts the received values that are same at least two received values as an accurate value. In this way, even if one of the other participants is a dishonest person, the participant can determine an accurate value. That is, even if there is a dishonest person, it is possible to realize Guaranteed Output Delivery (GOD) that can acquire an accurate computation without stopping the processes. In addition, because no hash function is used in the above processes, Guaranteed Output Delivery (GOD) is realized in a normal model.

In addition, in the secure computation system 100 and the secure computation method according to the present example embodiment, because reshare (local reshare) is first performed without communications and a secure computation with communications is next performed, reduction in communication cost is achieved.

The first example embodiment described above is an example embodiment for describing only a basic concept of the present invention. A second example embodiment described below is a practical example embodiment to which the above-described concept is applied.

### [Second Example Embodiment]

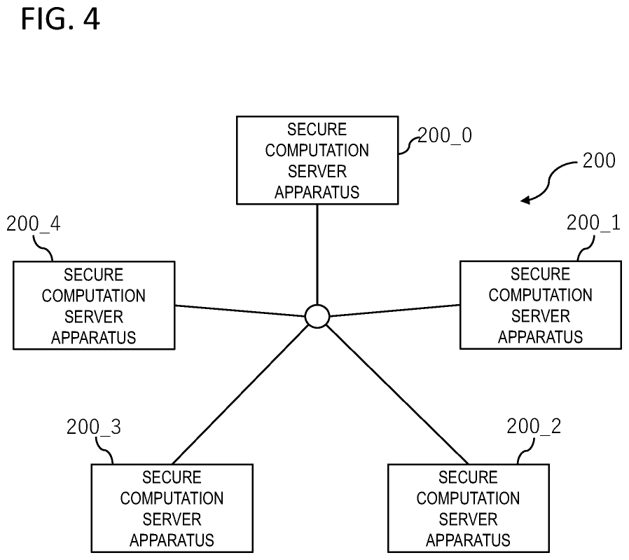

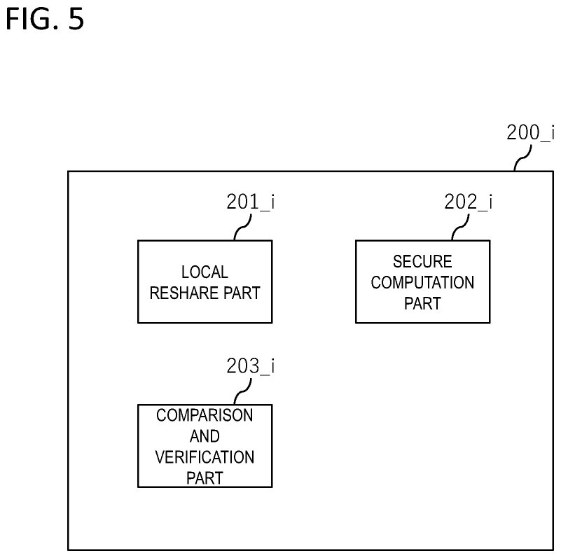

Hereinafter, a secure computation system and secure computation server apparatuses according to a second example embodiment will be described with reference to FIGS. 4 and 5.

FIG. 4 is a block diagram illustrating a functional configuration example of a secure computation system according to the second example embodiment. As illustrated in FIG. 4, a secure computation system 200 according to the second example embodiment includes a first secure computation server apparatus 200_0, a second secure computation server apparatus 200_1, a third secure computation server apparatus 200_2, a fourth secure computation server apparatus 200_3, and a fifth secure computation server apparatus 200_4. The first secure computation server apparatus 200_0, the second secure computation server apparatus 200 1, the third secure computation server apparatus 200_2, the fourth secure computation server apparatus 200_3, and the fifth secure computation server apparatus 200_4 are connected to each other via a network such that these apparatuses can communicate with each other.

In the secure computation system 200 including the first to fifth secure computation server apparatuses 200_i (i=0, 1, 2, 3, 4), it is possible to compute target shares from a value inputted to any one of the first to fifth secure computation server apparatuses 200_i (i=0, 1, 2, 3, 4) while keeping the input value and the values acquired in the computation processes secret, and it is possible to dispersedly store the computation results in the first to fifth secure computation server apparatuses 200_i (i=0, 1, 2, 3, 4).

In addition, in the secure computation system 200 including the first to fifth secure computation server apparatuses 200_i (i=0, 1, 2, 3, 4), even when one of the first to fifth secure computation server apparatuses 200_i (i=0, 1, 2, 3, 4) is operated by a dishonest person, it is possible to continue an accurate secure computation without stopping the processes.

FIG. 5 is a block diagram illustrating a functional configuration example of a secure computation server apparatus according to the second example embodiment. As illustrated in FIG. 5, in the secure computation system 200 according to the present example embodiment, an individual one of the first to fifth secure computation server apparatuses 200_i (i=0, 1, 2, 3, 4) includes a local reshare part 201_i, a secure computation part 202_i, and a comparison and verification part 203_i.

The local reshare part 201_i computes an arithmetic share without communicating with the other secure computation server apparatuses by setting a sub-share not held by its host secure computation server apparatus 200_i to zero from a logic share. The secure computation part 202_i performs a secure computation with communications by using the arithmetic share acquired by the local reshare part 201_i, to acquire an arithmetic share from the logic share through a bit conversion. The comparison and verification part 203_i compares received values with each other, which are received from at least three of the secure computation server apparatuses and which are supposed to be the same value, and adopts the received values that are same at least two received values as an accurate value. In this way, the comparison and verification part 203_i verifies the received values acquired in the secure computation with communications.

Hereinafter, building blocks used for execution of the bit conversion according to the present example embodiment will be described. Note that not all the building blocks used for execution of the bit conversion will be described. Of all the four basic arithmetic operations used for the secure computation, multiplication, which is not obvious, will be mainly described.

### [Generation of Pseudo Random Numbers and Sharing of Seeds]

Pseudo-random functions Fₙ and F2, seeds, and an identifier have a relationship as follows. The pseudo-random functions Fₙ and F2 are binary operations defined with a security parameter k.

Fₙ:{0,1}^{κ}×{0,1}^{κ}→{0,1}ⁿ

F₂: {0,1}^{κ}×{0,1}^{κ}→{0,1}²

Seeds seedᵢ∈{0,1}^{κ} (i=0, 1, 2, 3, 4) are values appropriately shared by the individual secure computation server apparatuses 200_i, and an identifier vid∈{0,1}^{κ} is a public value such as a counter. The pseudo-random functions Fₙ and F2 determinably generate pseudo random numbers by using the seeds and the identifier as their inputs.

Regarding the five seeds seedᵢ∈{0,1}^{κ} (i=0, 1, 2, 3, 4), an individual one of the secure computation server apparatuses 200_i holds (seedᵢ, seedᵢ₊₁, seedᵢ₊₂, seedᵢ₊₃). Note that seed₄₊₁=seed₀. That is, an individual one of the secure computation server apparatuses 200_i holds the seeds seedᵢ other than the seed seedᵢ₊₄. For example, the sharing of these seeds can be appropriately set by an administrator or the like as a presetting of the secure computation server apparatuses 200_i.

### [Creation of Mask]

Next, a pseudo random number (Correlated Randomness) that is seen as a random number by the participant Pᵢ₊₄ and cannot be removed and that can be determinably computed by the other participants Pᵢ, Pᵢ₊₁, Pᵢ₊₂, and Pᵢ₊₃ is created, and this pseudo random number will be used as a mask in the multiplication in the secure computation, which will be described below.

First, since the participant Pᵢ₊₄ does not hold the seed seedᵢ₊₃, if the seed seedᵢ₊₃ is used as an input of the pseudo-random function Fₙ, the following pseudo random number satisfies the above condition. That is, although the following αₖ is seen as a random number by the participant Pᵢ₊₄ and cannot be removed, the following αₖ can be determinably computed by the other participants Pᵢ, Pᵢ₊₁, Pᵢ₊₂, and Pᵢ₊₃.

αₖ=Fₙ(vidₖ,seedᵢ₊₃)−Fₙ(vidₖ₊₁,seedᵢ₊₃) mod n

In addition, by changing the index k in the identifier vidₖ from k=0 to k=4, five pseudo random numbers αₖ can be created. A set of these pseudo random numbers αₖ is defined as follows. Whether the following pseudo random numbers α₀, α₁, α₂, α₃, and α₄ determined as follows satisfy α₀+α₁+α₂+α₃+α₄=0 can be easily determined.

(α₀,α₁,α₂,α₃,α₄)=CR(i+4,{vidₖ}⁴ₖ₌₀,seedᵢ₊₃)

Although the pseudo random numbers α₁, α₁, α₂, α₃, and α₄ created as described above are seen as random numbers by the participant Pᵢ₊₄ and cannot be removed, these pseudo random numbers can be determinably computed by the other participants Pᵢ, Pᵢ₊₁, Pᵢ₊₂, and Pᵢ₊₃. However, although the pseudo random numbers α₀, α₁, α₂, α₃, and α₄ cannot be removed by the participant Pᵢ₊₄, if all the pseudo random numbers α₀, α₁, α₂, α₃, and α₄ are collected, because the sum is 0, the pseudo random numbers α₀, α₁, α₂, α₃, and α₄ can be removed by the participant Pᵢ₊₄.

In addition, the creation of the above pseudo random numbers can be performed in the same way for all the other participants Pᵢ₊₄. Specifically, the pseudo random numbers can be defined as follows.

(α_{i,0},α_{i,1},α_{i,2},α_{i,3},α_{i,4})=CR(i,{vidₖ}⁴ₖ₌₀,seedᵢ₊₄) for i=0, 1, 2, 3, 4

α_{i,k}=Fₙ(vidₖ,seedᵢ₊₄)−Fₙ(vidₖ₊₁,seedᵢ₊₄) mod n for i=0, 1, 2, 3, 4

The sets of pseudo random numbers created as described above are defined as follows.

TABLE 1

| | | | | |
|---|---|---|---|---|
| α_{0, 0} | α_{1, 0} | α_{2, 0} | α_{3, 0} | α_{4, 0} |
| α_{0, 1} | α_{1, 1} | α_{2, 1} | α_{3, 1} | α_{4, 1} |
| α_{0, 2} | α_{1, 2} | α_{2, 2} | α_{3, 2} | α_{4, 2} |
| α_{0, 3} | α_{1, 3} | α_{2, 3} | α_{3, 3} | α_{4, 3} |
| α_{0, 4} | α_{1, 4} | α_{2, 4} | α_{3, 4} | α_{4, 4} |

In the above table of the pseudo random numbers, the sum of first indexes (in the vertical direction) is zero, and the sum of second indexes (in the horizontal direction) is not zero.

### [Secure Computation (Multiplication)]

Next, multiplication, which is an important factor in the secure computation, will be described. That is, a specific example of a secure computation for calculating [z]=[x·y]=[x]·[y] from two shares [x] and [y] will be described. Note that x, y, and z have been decomposed as follows.

$$z = {\sum }_{i = 0}^{4} {z}_{i} mod n x = {\sum }_{i = 0}^{4} {x}_{i} mod n y = {\sum }_{i = 0}^{4} {y}_{i} mod n {z}_{i} = {x}_{i} \cdot {\sum }_{j = 0}^{4} {y}_{j} mod n \qquad [ Equations 2 ]$$

The participant Pᵢ (i=0, 1, 2, 3, 4) computes tmp_{zk} as follows. xₖ·yᵢ₊₄ is needed for the participant Pᵢ to compute zₖ (the participant Pᵢ cannot compute zₖ from the share held thereby), and this tmp_{zk} is a value that the participant Pᵢ computes instead. In the following Equation 3, α_{j,k} represents a pseudo random number described in the above section [Creation of Mask].

$${tmp}_{{z}_{k}} = {x}_{k} \cdot ( {y}_{i} + {y}_{i + 1} + {y}_{i + 2} + {y}_{i + 3} ) + {\sum }_{j \neq i} {α}_{j , k} mod n ( k = i , i + 1 , i + 2 , i + 3 ) \qquad [ Equation 3 ]$$

Next, sender groups Sᵢ, Sᵢ₊₁, Sᵢ₊₂, and Sᵢ₊₃ are defined as Sᵢ={Pᵢ₊₂, Pᵢ₊₃, Pᵢ₊₄}, Sᵢ₊₁={Pᵢ₊₃, Pᵢ₊₄, Pᵢ₊₁}, Sᵢ₊₂={Pᵢ₊₄, Pᵢ₊₁, Pᵢ₊₂}, and Sᵢ₊₃={Pᵢ₊₁, Pᵢ₊₂, Pᵢ₊₃}. In this way, the participants belonging to Sₖ can compute xₖyᵢ₊₄ from the shares held thereby. Thus, for example, the participants Pᵢ₊₂, Pᵢ₊₃, and Pᵢ₊₄ belonging to the sender group Sᵢ={Pᵢ₊₂, Pᵢ₊₃, Pᵢ₊₄} compute m_{k,i+2}, m_{k,i+3}, and m_{k,i+4} in which xₖ·yᵢ₊₄ is masked by the above pseudo random number α_{i,k}.

Pᵢ₊₂: m_{k,i+2}=α_{i,k}+xₖ·yᵢ₊₄ mod n

Pᵢ₊₃: m_{k,i+3}=α_{i,k}+xₖ·yᵢ₊₄ mod n

Pᵢ₊₄: m_{k,i+4}=α_{i,k}+xₖ·yᵢ₊₄ mod n

In addition, among the participants Pᵢ₊₂, Pᵢ₊₃, and Pᵢ₊₄ belonging to the sender group Sᵢ={Pᵢ₊₂, Pᵢ₊₃, Pᵢ₊₄}, for example, the participants Pᵢ₊₂ and Pᵢ₊₃ send m_{k,i+2} and m_{k,i+3} to the participant Pᵢ without change, and the participant Pᵢ₊₄ sends a hash value h_{k,i+4} of m_{k,i+4} to the participant Pᵢ. In this case, since m_{k,i+2}, m_{k,i+3}, and m_{k,i+4} are masked by the pseudo random number α_{i,k}, xₖyᵢ₊₄ will not be leaked. That is, although a hash function is used in this case, use of the hash function is not for ensuring security but for reducing the communication cost.

Next, upon receiving m_{k,i+2} and m_{k,i+3} and the hash value h_{k,i+4} of m_{k,i+4}, the participant Pᵢ performs comparison and verification on m_{k,i+2} and m_{k,i+3} and the hash value h_{k,i+4} of m_{k,i+4}. First, the participant Pᵢ computes hash values h_{k,i+2} and h_{k,i+3} of m_{k,i+2} and m_{k,i+3}. Next, if h_{k,i+2}=h_{k,i+3} or if h_{k,i+2}=h_{k,i+4}, the participant Pᵢ determines that mₖ=m_{k,i+2}. If h_{k,i+3}=h_{k,i+4}, the participant Pᵢ determines that mₖ=m_{k,i+2}.

When xₖyᵢ₊₄ is sent to the participant Pᵢ as described above, the participant Pᵢ receives the values mₖ (hash values thereof), which are supposed to be the same value, from at least three of the other participants Pⱼ and adopts the received values that are same at least two received values as an accurate value. In this way, even when one of the other participants Pⱼ is a dishonest person, it is possible to determine an accurate value.

Next, the participant Pᵢ computes zₖ=tmp_{zk}+mₖ mod n (k=i, i+1, i+2, i+3) by using mₖ, which has been determined to be an accurate value.

$${z}_{k} = {tmp}_{{z}_{k}} + {m}_{k} = ( {x}_{k} \cdot ( {y}_{i} + {y}_{i + 1} + {y}_{i + 2} + {y}_{i + 3} ) + {\sum }_{j \neq i} {α}_{j , k} ) + ( {α}_{j , k} + {x}_{k} \cdot {y}_{i + 4} ) = {x}_{k} \cdot {\sum }_{j = 0}^{4} {y}_{j} + {\sum }_{j = 0}^{4} {α}_{j , k} \qquad [ Equation 4 ]$$

Although zₖ calculated as described above includes an extra additional term, zₖ functions as a share [z]ᵢ=(zᵢ, zᵢ₊₁, zᵢ₊₂, zᵢ₊₃) of the computation result of [z]=[xy]=[x][y]. This becomes clear when z=z₀+z₁+z₂+z₃+z₄ is actually computed as follows.

$$z = {z}_{0} + {z}_{1} + {z}_{2} + {z}_{3} + {z}_{4} = ( {x}_{0} \cdot {\sum }_{j = 0}^{4} {y}_{j} + {\sum }_{j = 0}^{4} {α}_{j , 0} ) + ( {x}_{1} \cdot {\sum }_{j = 0}^{4} {y}_{j} + {\sum }_{j = 0}^{4} {α}_{j , 1} ) + ( {x}_{2} \cdot {\sum }_{j = 0}^{4} {y}_{j} + {\sum }_{j = 0}^{4} {α}_{j , 2} ) + ( {x}_{3} \cdot {\sum }_{j = 0}^{4} {y}_{j} + {\sum }_{j = 0}^{4} {α}_{j , 3} ) + ( {x}_{4} \cdot {\sum }_{j = 0}^{4} {y}_{j} + {\sum }_{j = 0}^{4} {α}_{j , 4} ) = ( {x}_{0} + {x}_{1} + {x}_{3} + {x}_{4} ) \cdot {\sum }_{j = 0}^{4} {y}_{j} + {\sum }_{k = 0}^{4} {α}_{0 , k} + {\sum }_{k = 0}^{4} + {α}_{1 , k} + {\sum }_{k = 0}^{4} {α}_{2 , k} + {\sum }_{k = 0}^{4} {α}_{3 , k} + {\sum }_{k = 0}^{4} {α}_{4 , k} = x \cdot y mod n \qquad [ Equation 5 ]$$

The reason why the pseudo random number α_{i,k} can be removed is that the following relational expression is established from the construction of the pseudo random number.

$${\sum }_{k = 0}^{4} {α}_{0 , k} = {\sum }_{k = 0}^{4} {α}_{1 , k} = {\sum }_{k = 0}^{4} {α}_{2 , k} = {\sum }_{k = 0}^{4} {α}_{3 , k} = {\sum }_{k = 0}^{4} {α}_{4 , k} = 0 \qquad [ Equation 6 ]$$

That is, as described in the above section [Creation of Mask], the pseudo random numbers having the present construction have the nature that the sum of first indexes (in the vertical direction) is zero and that the sum of second indexes (in the horizontal direction) is not zero. The additional term that appears in the computation result of zₖ=tmp_{zk}+mₖ mod n (k=i, i+1, i+2, i+3) is the sum of the second indexes (in the horizontal direction) and is not zero. However, when the computation result of [z]=[x·y]=[x]·[y] is reconstructed, it becomes consequently possible to remove the impact of the additional term (mask) by using the nature that the sum of first indexes (in the vertical direction) is zero. That is, although zₖ calculated as described above includes the extra additional term, zₖ functions as a share [z]ᵢ=(zᵢ, zᵢ₊₁, zᵢ₊₂, zᵢ₊₃) of the computation result of [z]=[x·y ]=[x]·[y].

Thus, regarding the share [z]ᵢ=(zᵢ, zᵢ₊₁, zᵢ₊₂, zᵢ₊₃) of the computation result of [z]=[x·y]=[x]·[y] as described above, a participant Pᵢ receives the values mₖ (hash values thereof), which are supposed to be the same value, from at least three of the other participants Pⱼ and adopts the received values that are same at least two received values as an accurate value. In this way, even when one of the other participants Pⱼ is a dishonest person, it is possible to determine an accurate value. That is, even if there is a dishonest person, it is possible to realize Guaranteed Output Delivery (GOD) that can acquire an accurate computation without stopping the processes. In addition, although a hash function is used in the above processes, this is to reduce the communication amount. Even if the input is deduced from the output, the security is not affected. Thus, Guaranteed Output Delivery (GOD) in a standard model is realized.

### [Bit Conversion]

The bit conversion is a bit conversion: [x]←BC ([x]^{B}) for acquiring arithmetic shares [x] on a residue class ring Zₙ of order n from logic shares [x]^{B} on a residue class ring Z₂ of modulo 2. First, as local reshare, an individual secure computation server apparatus performs reshare from a logic share to an arithmetic share without communicating with the other secure computation server apparatuses, by setting a sub-share not held thereby to zero. Specifically, the local reshare is performed as follows.

The individual participants Pi (i=0, 1, 2, 3, 4) set [x₀]ᵢ as follows.
P₀: [x₀]₀=(x₀,0,0,0)
P₁: [x₀]₁=(0,0,0,0)
P₂: [x₀]₂=(0,0,0,x₀)
P₃: [x₀]₃=(0,0,x₀,0)
P₄: [x₀]₄=(0,x₀,0,0)

The individual participants Pi (i=0, 1, 2, 3, 4) set [x₁]ᵢ as follows.
P₀: [x₁]₀=(0,x₁,0,0)
P₁: [x₁]₁=(x₁,0,0,0)
P₂: [x₁]₂=(0,0,0,0)
P₃: [x₁]₃=(0,0,0,x₁)
P₄: [x₁]₄=(0,0,x₁,0)

The individual participants Pi (i=0, 1, 2, 3, 4) set [x₂]ᵢ as follows.
P₀: [x₂]₀=(0,0,x₂,0)
P₁: [x₂]₁=(0,x₂,0,0)
P₂: [x₂]₂=(x₂,0,0,0)
P₃: [x₂]₃=(0,0,0,0)
P₄: [x₂]₄=(0,0,0,x₂)

The individual participants Pi (i=0, 1, 2, 3, 4) set [x₃]ᵢ as follows.
P₀: [x₃]₀=(0,0,0,x₃)
P₁: [x₃]₁=(0,0,x₃,0)
P₂: [x₃]₂=(0,x₃,0,0)
P₃: [x₃]₃=(x₃,0,0,0)
P₄: [x₃]₄=(0,0,0,0)

The individual participants Pi (i=0, 1, 2, 3, 4) set [x₄]ᵢ as follows.
P₀: [x₄]₀=(0,0,0,0)
P₁: [x₄]₁=(0,0,0,x₄)
P₂: [x₄]₂=(0,0,x₄,0)
P₃: [x₄]₃=(0,x₄,0,0)
P₄: [x₄]₄=(x₄,0,0,0)

The above local reshare is not a computation with communications, and therefore, even if one of the participants is a dishonest person, the execution of the computation is not affected.

Next, a secure computation with communications is performed by using the arithmetic share reshared as described above, to acquire an arithmetic share from the logic share through a bit conversion. Note that, for example, although, as shares of an element x of the residue class ring Z₂ of modulo 2, that is, x∈Z₂, on residue class ring Z₂, (1, 0, 0, 0, 0) and (1, 1, 1, 1, 1) are the same value, (1, 0, 0, 0, 0) and (1, 1, 1, 1, 1) are not the same value, as shares of an element x of the residue class ring Zₙ of modulo n, that is, x∈Zₙ, on residue class ring Zₙ. This is because decomposition using an exclusive-or does not match decomposition of an arithmetic sum. Thus, the following secure computation is performed to cancel out the difference between the exclusive-or and arithmetic sum.

[x₀⊕x₁]=([x₀]−[x₁])²

[x₂⊕x₃]=([x₂]−[x₃])²

[(x₀⊕x₁)⊕(x₂⊕x₃)]=([x₀⊕x₁]−[x₂⊕x₃])²

[x]=[(x₀⊕x₁)⊕(x₂⊕x₃)⊕x₄]=([(x₀⊕x₁)⊕(x₂⊕x₃)]−[x₄])² [Equations 7]

The above secure computation includes squares, that is, multiplications. These multiplications need communications with the other secure computation server apparatuses. Thus, by using the above [Secure Computation (Multiplication)], a secure computation server apparatus compares received values with each other, which are received from at least three of the secure computation server apparatuses and which are supposed to be the same value, and adopts the received values that are same at least two received values as an accurate value. In this way, the secure computation server apparatus verifies the received values acquired in the secure computation with communications.

As described above, in the secure computation system 200 and the secure computation method according to the second example embodiment, a participant receives received values, which are received from at least three of the other participants and which are supposed to be the same value, and adopts the received values that are same at least two received values as an accurate value. In this way, even if one of the other participants is a dishonest person, the participant can determine an accurate value. That is, even if there is a dishonest person, it is possible to realize Guaranteed Output Delivery (GOD) that can acquire accurate computation without stopping the processes.

In addition, although a hash function is used in the above processes, this is to reduce the communication amount. Even if the input is deduced from the output, the security is not affected. Thus, Guaranteed Output Delivery (GOD) in a standard model is realized. In addition, in the secure computation system 200 and the secure computation method according to the present example embodiment, because reshare (local reshare) is first performed without communications, and a secure computation with communications is next performed, reduction in communication cost is achieved.

### [Third Example Embodiment]

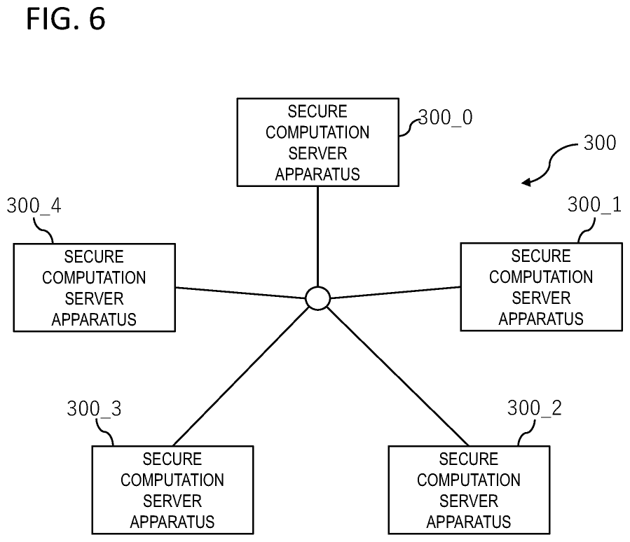

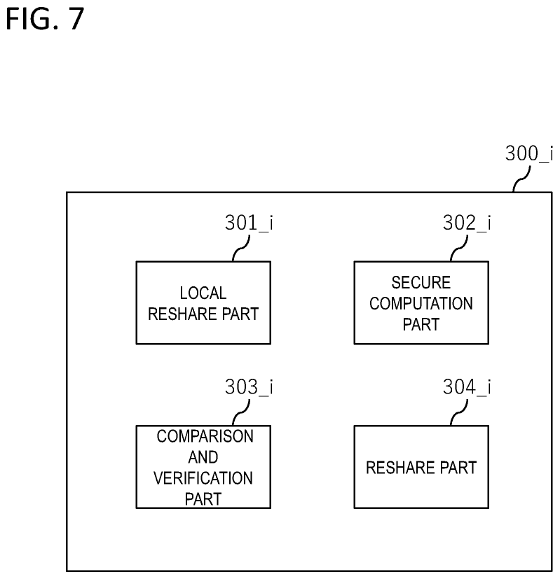

Next, a secure computation system and secure computation server apparatuses according to a third example embodiment will be described with reference to FIGS. 6 and 7.

FIG. 6 is a block diagram illustrating a functional configuration example of a secure computation system according to the third example embodiment. As illustrated in FIG. 6, a secure computation system 300 according to the third example embodiment includes a first secure computation server apparatus 300_0, a second secure computation server apparatus 300_1, a third secure computation server apparatus 300_2, a fourth secure computation server apparatus 300_3, and a fifth secure computation server apparatus 300_4. The first secure computation server apparatus 300_0, the second secure computation server apparatus 300_1, the third secure computation server apparatus 300_2, the fourth secure computation server apparatus 300_3, and the fifth secure computation server apparatus 300_4 are connected to each other via a network such that these apparatuses can communicate with each other.

In the secure computation system 300 including the first to fifth secure computation server apparatuses 300_i (i=0, 1, 2, 3, 4), it is possible to compute target shares from a value inputted to any one of the first to fifth secure computation server apparatuses 300_i (i=0, 1, 2, 3, 4) while keeping the input value and the values acquired in the computation processes secret, and it is possible to dispersedly store the computation results in the first to fifth secure computation server apparatuses 300_i (i=0, 1, 2, 3, 4).

In addition, in the secure computation system 300 including the first to fifth secure computation server apparatuses 300_i (i=0, 1, 2, 3, 4), even when one of the first to fifth secure computation server apparatuses 300_i (i=0, 1, 2, 3, 4) is operated by a dishonest person, it is possible to continue an accurate secure computation without stopping the processes.

FIG. 7 is a block diagram illustrating a functional configuration example of a secure computation server apparatus according to the third example embodiment. As illustrated in FIG. 7, in the secure computation system 300 according to the present example embodiment, each of the first to fifth secure computation server apparatus 300_i (i=0, 1, 2, 3, 4) includes a local reshare part 301_i, a secure computation part 302_i, a comparison and verification part 303_i, and a reshare part 304_i.

The local reshare part 301_i computes an arithmetic share without communicating with the other secure computation server apparatuses by setting a sub-share not held by its host secure computation server apparatus 300_i to zero from a logic share. The secure computation part 302_i performs a secure computation with communications by using the arithmetic share acquired by the local reshare part 301_i, to acquire an arithmetic share from the logic share through a bit conversion. The comparison and verification part 303_i compares received values with each other, which are received from at least three of the secure computation server apparatuses and which are supposed to be the same value, and adopts the received values that are same at least two received values as an accurate value. In this way, the comparison and verification part 303_i verifies the received values acquired in the secure computation with communications. The reshare part 304_i reshares the temporary variables computed from the sub-shares in the logic share as arithmetic shares.

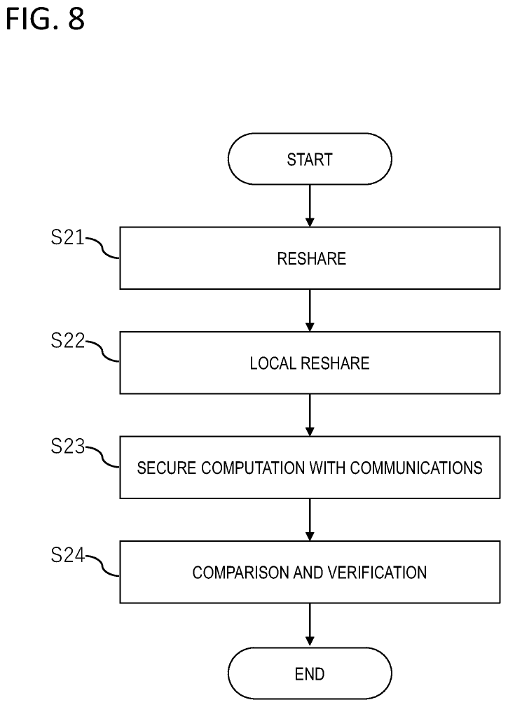

As described above, the secure computation server apparatus 300_i according to the third example embodiment includes the reshare part 304_i, in addition to the configuration of the secure computation server apparatus 200_i according to the second example embodiment. Hereinafter, the function of this reshare part 304_i in a secure computation method will be described. FIG. 8 is a flowchart illustrating an outline of a procedure of the secure computation method.

As illustrated in FIG. 8, the secure computation method according to the present example embodiment includes a reshare step (S21), a local reshare step (S22), a secure computation step (S23) with communications, and a comparison and verification step (S24). In the reshare step (S21), temporary variables computed from sub-shares in a logic share are reshared as arithmetic shares. In the local reshare step (S22), a secure computation server apparatus computes an arithmetic share without communicating with the other secure computation server apparatuses, by setting a sub-share not held thereby to zero from the logic share. The local reshare step (S22) may be performed before the reshare step (S21).

In the secure computation step (S23) with communications, to acquire an arithmetic share from the logic share through a bit conversion, the individual secure computation server apparatus performs a secure computation with communications by using the arithmetic share on which the local reshare has been performed. Next, in the comparison and verification step (S24), the individual secure computation server apparatus compares received values with each other, which are received from at least three of the secure computation server apparatuses and which are supposed to be the same value, and adopts the received values that are same at least two received values as an accurate value. In this way, the individual secure computation server apparatus verifies the received values acquired in the secure computation with communications. The comparison and verification step (S24) is performed each time the secure computation with communications is performed. Thus, the comparison and verification step (S24) is performed not only on the received values acquired in the secure computation step (S23) with communications but also on the received values in the reshare step (S21).

### [Reshare]

First, the function of the reshare part 304_i added in the present example embodiment will be described. The reshare used in the present example embodiment is defined as follows. That is, the reshare is determinably defined from seeds and an identifier when participants Pᵢ, Pᵢ₊₁ and Pᵢ₊₂ hold a value c.

$$[ c ] ← Reshare ( {P}_{i} , {P}_{i + 1} , {P}_{i + 2} , c , {\{ vi {d}_{j} \}}_{j = 1}^{4} , {seed}_{i + 2} , {seed}_{i + 3} ) \qquad [ Equation 8 ]$$

$${c}_{i} = \begin{matrix}c - {r}_{1} - {r}_{2} - {r}_{3} - {r}_{4} - {r}_{1}^{′} - {r}_{2}^{′} - {r}_{3}^{′} - {r}_{4}^{′} & ( i = 0 ) \\ {r}_{i} + {r}_{i}^{′} & ( else )\end{matrix}$$

$$where c = {c}_{0} + {c}_{1} + {c}_{2} + {c}_{3} + {c}_{4} mod n$$

Note that rⱼ=Fₙ (vidₖ, seedᵢ₊₂) and r′ⱼ=Fₙ (vidₖ₊₁, seedᵢ₊₃), and that the seeds seedᵢ∈{0, 1}^{κ} (i=0, 1, 2, 3, 4) are those having the nature described in the above section [Generation of Pseudo Random Number and Sharing of Seeds]. Thus, a participant Pᵢ₊₃ does not know seedᵢ₊₂, and a participant Pᵢ₊₄ does not know seedᵢ₊₃. That is, the participant Pᵢ₊₃ cannot compute cᵢ₊₃ by himself or herself and the participant Pᵢ₊₄ cannot compute cᵢ₊₄ by himself or herself. Therefore, the participant Pᵢ₊₃ needs to receive cᵢ₊₃ from the participants Pᵢ, Pᵢ₊₁, and Pᵢ₊₂, and the participant Pᵢ₊₄ needs to receive cᵢ₊₄ from the participants Pᵢ, Pᵢ₊₁, and Pᵢ₊₂.

In this step, since a secure computation with communications is performed, the participant Pᵢ₊₃ compares the received values cᵢ₊₃, which are received from the participants Pᵢ, Pᵢ₊₁, and Pᵢ₊₂ and which are supposed to be the same value, and adopts the received values that are same at least two received values as an accurate value. Similarly, the participant Pᵢ₊₄ compares the received values cᵢ₊₄, which are received from the participants Pᵢ, Pᵢ₊₁, and Pᵢ₊₂ and which are supposed to be the same value, and adopts the received values that are same at least two received values as an accurate value. Specifically, this step can be performed as follows.

The participants Pᵢ and Pᵢ₊₁ send cⱼ₊₁, cⱼ₊₂, and cⱼ₊₃ (j=i+3) to the participant Pᵢ₊₃. In contrast, the participant Pᵢ₊₂ sends hash values of cⱼ₊₁, cⱼ₊₂, and cⱼ₊₃ (j=i+3) to the individual participant. In addition, the participants Pᵢ and Pᵢ₊₁ send c_{j′+1}, c_{j′+2}, and c_{j′+3} (j′=i+3) to the participant Pᵢ₊₄. In contrast, the participant Pᵢ₊₂ sends c_{j′+1}, c_{j′+2}, and c_{j′+3} (j′=i+3) to the individual participant. Next, each of the participants Pᵢ₊₃ and Pᵢ₊₄ adopts the received values received from the participants Pᵢ, Pᵢ₊₁, and Pᵢ₊₂ that are same at least two received values as an accurate value.

Next, how the above-described reshare is used in the bit conversion will be described.

### [Bit Conversion]

The bit conversion is a bit conversion: [x]←BC ([x]^{B}) for acquiring arithmetic shares [x] on a residue class ring Zₙ of modulo n from logic shares [x]^{B} on a residue class ring Z₂ of modulo 2. First, the participants P₃, P₄, and P₀ and the participants P₀, P₁, and P₂ compute temporary variables y₀ and y₁ from sub-shares xᵢ in the logic share [x]^{B} as follows.

y₀=x₀⊕x₁

y₁=x₂⊕x₃ [Equations 9]

Next, the participants P₃, P₄, and P₀ and the participants P₀, P₁, and P₂ reshare the temporary variables y₀ and y₁.

[y₀]←Reshare(P₃,P₄,P₀,y₀,{vid_{0,k}}ₖ₌₁⁴,seed₀,seed₁)

[y₁]←Reshare(P₀,P₁,P₂,y₁,{vid_{1,k}}ₖ₌₁⁴,seed₂,seed₃) [Equations 10]

As described above, since the above reshare is a secure computation with communications, each of the participants Pᵢ₊₃ and Pᵢ₊₄ adopts the received values received from the participants Pᵢ, Pᵢ₊₁, and Pᵢ₊₂ that are same at least two received values as an accurate value.

In contrast, the individual participant Pi (i=0, 1, 2, 3, 4) sets [x₄]ᵢ as follows. This process is not a secure computation with communications, and therefore, no verification is needed.
P₀: [x₄]₀=(0,0,0,0)
P₁: [x₄]₁=(0,0,0,x₄)
P₂: [x₄]₂=(0,0,x₄,0)
P₃: [x₄]₃=(0,x₄,0,0)
P₄: [x₄]₄=(x₄,0,0,0)

Next, finally, by using the arithmetic shares of the temporary variables y₀ and y₁ and the arithmetic shares [x₄]ᵢ (i=0, 1, 2, 3, 4), the individual participant Pi (i=0, 1, 2, 3, 4) performs a secure computation as follows to obtain an arithmetic share from the logic share through a bit conversion.

[y₁⊕x₄]=([y₁]−[x₄])²

[x]=[y₁⊕x₄+y₀]=([y₁⊕x₄]−[y₀])² [Equations 11]

In this step, too, the above secure computation includes multiplications. Thus, by using the above [Secure Computation (Multiplication)], the individual participant Pi compares received values, which are received from at least three of the secure computation server apparatuses and which are supposed to be the same value, and adopts the received values that are same at least two received values as an accurate value. In this way, the participant Pi verifies the received values acquired in the secure computation with communications.

As described above, in the secure computation system 300 and the secure computation method according to the third example embodiment, a participant receives received values, which are received from at least three of the other participants and which are supposed to be the same value, and adopts the received values that are same at least two received values as an accurate value. In this way, even if one of the other participants is a dishonest person, the participant can determine an accurate value. That is, even if there is a dishonest person, it is possible to realize Guaranteed Output Delivery (GOD) that can acquire an accurate computation without stopping the processes.

In addition, although a hash function is used in the above processes, this is to reduce the communication amount. Even if the input is deduced from the output, the security is not affected. Thus, Guaranteed Output Delivery (GOD) in a standard model is realized. In addition, in the secure computation system 300 and the secure computation method according to the present example embodiment, because reshare (local reshare) is first performed without communications, and a secure computation with communications is next performed, reduction in communication cost is achieved.

In particular, in the secure computation system 300 and the secure computation method according to the third example embodiment, reshare with communications and reshare without communications are used in combination, and therefore, the communication cost is less than that achieved according to the second example embodiment. Specifically, regarding the communication cost according to the second example embodiment, the number of rounds is 3, and the communication amount is 160 kbits. In contrast, regarding the communication cost according to the third example embodiment, the number of rounds is 3, and the communication amount is 112 kbits. That is, compared with the second example embodiment, the secure computation system 300 and the secure computation method according to the third example embodiment can reduce the communication amount by 48 kbis with the same number of rounds.

### [Hardware Configuration Example]

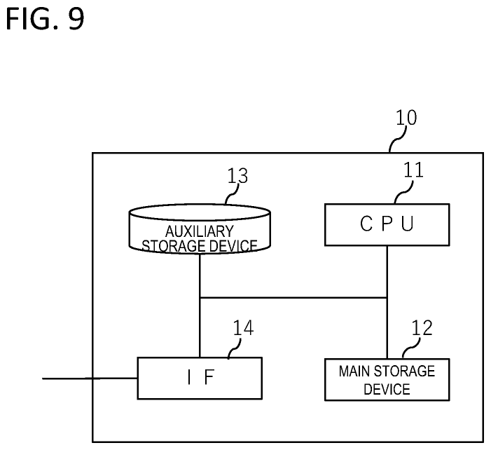

FIG. 9 is a diagram illustrating a hardware configuration example of a secure computation server apparatus. That is, the hardware configuration example illustrated in FIG. 9 is a hardware configuration example of any one of the secure computation server apparatuses 100_i, 200_i, and 300_i (i=0, 1, 2, 3, 4). An information processing apparatus (a computer) that adopts the hardware configuration illustrated in FIG. 9 can realize the individual functions of any one of the secure computation server apparatuses 100_i, 200_i, and 300_i (i=0, 1, 2, 3, 4) by executing the corresponding one of the above secure computation methods as a program.

The hardware configuration example illustrated in FIG. 9 is an example of the hardware configuration that realizes the individual functions of any one of the secure computation server apparatuses 100_i, 200_i, and 300_i (i=0, 1, 2, 3, 4), and does not limit the hardware configuration of any one of the secure computation server apparatuses 100_i, 200_i, and 300_i (i=0, 1, 2, 3, 4). The secure computation server apparatuses 100_i, 200_i, and 300_i (i=0, 1, 2, 3, 4) may include hardware not illustrated in FIG. 9.

As illustrated in FIG. 9, a hardware configuration 10 that can be adopted by any one of the secure computation server apparatuses 100_i, 200_i, and 300_i (i=0, 1, 2, 3, 4) includes, for example, a CPU (Central Processing Unit) 11, a main storage device 12, an auxiliary storage device 13, and an IF (Interface) part 14, which are connected to each other via an internal bus.

The CPU 11 executes various commands included in the secure computation program executed by the corresponding one of the secure computation server apparatuses 100_i, 200_i, and 300_i (i=0, 1, 2, 3, 4). The main storage device 12 is, for example, a RAM (Random Access Memory) and temporarily stores various kinds of programs such as the secure computation program executed by the corresponding one of the secure computation server apparatuses 100_i, 200_i, and 300_i (i=0, 1, 2, 3, 4) so that the CPU 11 can execute the programs.

The auxiliary storage device 13 is, for example, an HDD (Hard Disk Drive) and can store, in the mid-to-long term, various kinds of programs such as the secure computation program executed by the corresponding one of the secure computation server apparatuses 100_i, 200_i, and 300_i (i=0, 1, 2, 3, 4). These various kinds of programs such as the secure computation program can be recorded in a non-transitory computer-readable storage medium and can be provided as a program product. The auxiliary storage device 13 can be used to store, in the mid-to-long term, various kinds of programs such as the secure computation program recorded in a non-transitory computer-readable storage medium. The IF part 14 provides an interface regarding the input and output among the corresponding secure computation server apparatuses 100_i, 200_i, or 300_i (i=0, 1, 2, 3, 4).

An information processing apparatus that adopts the hardware configuration 10 as described above realizes the functions of any one of the secure computation server apparatuses 100_i, 200_i, and 300_i (i=0, 1, 2, 3, 4) by executing the corresponding one of the above-described secure computation methods as a program.

The above example embodiments can partially or entirely be described, but not limited to, as the following notes.

### [Note 1]

A secure computation system, which includes five secure computation server apparatuses connected to each other via a network and which performs a bit conversion from logic shares on a residue class ring of modulo 2 that are held in a secret sharing manner to arithmetic shares on a residue class ring of modulo n (n=2^{m}; m is an integer of 2 or more), an individual one of the secure computation server apparatuses including:
a local reshare part that computes an arithmetic share from the logic shares without communicating with the other secure computation server apparatuses by setting a sub-share not held by its host secure computation server apparatus to zero;
a secure computation part that performs a secure computation with communications by using the arithmetic share acquired by the local reshare part, to acquire an arithmetic share from the logic share through a bit conversion; and
a comparison and verification part that compares received values with each other, which are received from at least three of the secure computation server apparatuses and which are supposed to be a same value, and adopts the received values that are same at least two received values as an accurate value;
wherein the comparison and verification part verifies the received values acquired in the secure computation with communications.

### [Note 2]

The secure computation system according to note 1;
wherein the individual one of the secure computation server apparatuses further includes a reshare part that shares, as arithmetic shares, temporary variables computed from sub-shares in the logic shares;
wherein the comparison and verification part verifies received values of the arithmetic shares of the temporary variables shared by the reshare part; and
wherein, by using the arithmetic shares of the temporary variables shared by the reshare part and the arithmetic share obtained by the local reshare part, the secure computation part performs a secure computation to obtain an arithmetic share from the logic share through a bit conversion.

### [Note 3]

The secure computation system according to note 2;
wherein the temporary variables are computed from sub-shares in the logic share commonly held by three of the five secure computation server apparatuses;
wherein the reshare part shares arithmetic shares determinably generated from the temporary variables commonly computed by the three secure computation server apparatuses; and
wherein, regarding the arithmetic shares received from the three secure computation server apparatuses, the comparison and verification part adopts the received values that are same at least two or more received values as an accurate value.

### [Note 4]

The secure computation system according to any one of notes 1 to 3; wherein the comparison and verification part determines that the received values are each an accurate value by determining that hash values of the received values are same.

### [Note 5]

A secure computation server apparatus, which is one of at least five secure computation server apparatuses connected to each other via a network for performing a bit conversion from logic shares on a residue class ring of modulo 2 that are held in a secret sharing manner to arithmetic shares on a residue class ring of modulo n (n=2^{m}; m is an integer of 2 or more), the secure computation server apparatus including:
a local reshare part that computes an arithmetic share from the logic shares without communicating with the other secure computation server apparatuses by setting a sub-share not held by its host secure computation server apparatus to zero;
a secure computation part that performs a secure computation with communications by using the arithmetic share acquired by the local reshare part, to acquire an arithmetic share from the logic share through a bit conversion; and
a comparison and verification part that compares received values with each other, which are received from at least three of the secure computation server apparatuses and which are supposed to be a same value, and adopts the received values that are same at least two received values as an accurate value;
wherein the comparison and verification part verifies the received values acquired in the secure computation with communications.

### [Note 6]

A secure computation method, for performing a bit conversion from logic shares on a residue class ring of modulo 2 that are held in a secret sharing manner to arithmetic shares on a residue class ring of modulo n (n=2^{m}; m is an integer of 2 or more) by using five secure computation server apparatuses connected to each other via a network, the secure computation method including:
causing an individual one of the secure computation server apparatuses to perform reshare to an arithmetic share from the logic shares without communicating with the other secure computation server apparatuses by setting a sub-share not held thereby to zero;
causing the individual one of the secure computation server apparatuses to perform a secure computation with communications by using the arithmetic share acquired by the reshare, to acquire an arithmetic share from the logic share through a bit conversion; and
causing the individual one of the secure computation server apparatuses to compare received values with each other, which are received from at least three of the secure computation server apparatuses and which are supposed to be a same value, and adopt the received values that are same at least two received values as an accurate value, so as to verify the received values acquired in the secure computation with communications.

### [Note 7]

The secure computation method according to note 6; wherein the individual one of the secure computation server apparatuses performs:
resharing, as arithmetic shares, temporary variables computed from sub-shares in the logic shares;
comparing received values with each other, which are received from at least three of the secure computation server apparatuses and which are supposed to be a same value, and adopting at least two of the received values, the two received values being the same value, as an accurate value, so as to verify the received values of the arithmetic shares of the reshared temporary variables; and
performing, by using the arithmetic shares of the reshared temporary variables and the arithmetic share computed without communications, a secure computation to obtain an arithmetic share from the logic share through a bit conversion.

### [Note 8]

The secure computation method according to note 7;

wherein the temporary variables are computed from sub-shares in the logic share commonly held by three of the five secure computation server apparatuses;
wherein arithmetic shares determinably generated from the temporary variables commonly computed by the three secure computation server apparatuses are reshared; and
wherein, regarding the arithmetic shares received from the three secure computation server apparatuses, the received values that are same at least two or more received value is adopted as an accurate value.

### [Note 9]

The secure computation method according to any one of notes 6 to 8; wherein it is determined that the received values are each an accurate value by determining that hash values of the received values are same.

### [Note 10]

A secure computation program, causing at least five secure computation server apparatuses connected to each other via a network to perform a secure computation on values held in a secret sharing manner and causing five secure computation server apparatuses connected to each other via a network to perform a bit conversion from logic shares on a residue class ring of modulo 2 that are held in a secret sharing manner to arithmetic shares on a residue class ring of modulo n (n=2^{m}; m is an integer of 2 or more), an individual one of the secure computation server apparatuses performing:
resharing to an arithmetic share from the logic shares without communicating with the other secure computation server apparatuses by setting a sub-share not held thereby to zero;
a secure computation with communications by using the arithmetic share acquired by the reshare, to acquire an arithmetic share from the logic share through a bit conversion; and comparing received values with each other, which are received from at least three of the secure computation server apparatuses and which are supposed to be a same value, and adopting the received values that are same at least two received values as an accurate value, so as to verify the received values acquired in the secure computation with communications.

The disclosure of the above NPL is incorporated herein by reference thereto. Modifications and adjustments of the example embodiments or examples are possible within the scope of the overall disclosure (including the claims) of the present invention and based on the basic technical concept of the present invention. Various combinations or selections (including partial deletion) of various disclosed elements (including the elements in each of the claims, example embodiments, examples, drawings, etc.) are possible within the scope of the disclosure of the present invention. That is, the present invention of course includes various variations and modifications that could be made by those skilled in the art according to the overall disclosure including the claims and the technical concept. The description discloses numerical value ranges. However, even if the description does not particularly disclose arbitrary numerical values or small ranges included in the ranges, these values and ranges should be deemed to have been specifically disclosed. In addition, as needed and based on the gist of the present invention, partial or entire use of the individual disclosed matters in the above literatures that have been referred to in combination with what is disclosed in the present application should be deemed to be included in what is disclosed in the present application, as a part of the disclosure of the present invention.

### REFERENCE SIGNS LIST

100, 200, 300 secure computation system
100 i, 200_i, 300_i secure computation server apparatus
101_i, 201_i, 301_i local reshare part
102_i, 202_i, 302_i secure computation part
103_i, 203_i, 303_i comparison and verification part
304_i reshare part
10 hardware configuration
11 CPU (Central Processing Unit)
12 main storage device
13 auxiliary storage device
14 IF (Interface) part

What is claimed is:

1. A secure computation system, which includes five secure computation server apparatuses connected to each other via a network and which performs a bit conversion from logic shares on a residue class ring of modulo 2 that are held in a secret sharing manner to arithmetic shares on a residue class ring of modulo n (n=2^{m}; m is an integer of 2 or more), an individual one of the secure computation server apparatuses comprising:
a local reshare part that computes an arithmetic share from the logic shares without communicating with the other secure computation server apparatuses by setting a sub-share not held by its host secure computation server apparatus to zero;
a secure computation part that performs a secure computation with communications by using the arithmetic share acquired by the local reshare part, to acquire an arithmetic share from the logic share through a bit conversion; and
a comparison and verification part that compares received values with each other, which are received from at least three of the secure computation server apparatuses and which are supposed to be a same value, and adopts the received values that are same at least two received values as an accurate value;
wherein the comparison and verification part verifies the received values acquired in the secure computation with communications.

2. The secure computation system according to claim 1;
wherein the individual one of the secure computation server apparatuses further includes a reshare part that shares, as arithmetic shares, temporary variables computed from sub-shares in the logic shares;
wherein the comparison and verification part verifies received values of the arithmetic shares of the temporary variables shared by the reshare part; and
wherein, by using the arithmetic shares of the temporary variables shared by the reshare part and the arithmetic share obtained by the local reshare part, the secure computation part performs a secure computation to obtain an arithmetic share from the logic share through a bit conversion.

3. The secure computation system according to claim 2;
wherein the temporary variables are computed from sub-shares in the logic share commonly held by three of the five secure computation server apparatuses;
wherein the reshare part shares arithmetic shares determinably generated from the temporary variables commonly computed by the three secure computation server apparatuses; and
wherein, regarding the arithmetic shares received from the three secure computation server apparatuses, the comparison and verification part adopts the received values that are same at least two or more received values as an accurate value.

4. The secure computation system according to claim 1; wherein the comparison and verification part determines that the received values are each an accurate value by determining that hash values of the received values are same.

5. A secure computation server apparatus, which is one of at least five secure computation server apparatuses connected to each other via a network for performing a bit conversion from logic shares on a residue class ring of modulo 2 that are held in a secret sharing manner to arithmetic shares on a residue class ring of modulo n (n=2^{m}; m is an integer of 2 or more), the secure computation server apparatus comprising:
a local reshare part that computes an arithmetic share from the logic shares without communicating with the other secure computation server apparatuses by setting a sub-share not held by its host secure computation server apparatus to zero;
a secure computation part that performs a secure computation with communications by using the arithmetic share acquired by the local reshare part, to acquire an arithmetic share from the logic share through a bit conversion; and
a comparison and verification part that compares received values with each other, which are received from at least three of the secure computation server apparatuses and which are supposed to be a same value, and adopts the received values that are same at least two received values as an accurate value;
wherein the comparison and verification part verifies the received values acquired in the secure computation with communications.

6. A secure computation method, for performing a bit conversion from logic shares on a residue class ring of modulo 2 that are held in a secret sharing manner to arithmetic shares on a residue class ring of modulo n (n=2^{m}; m is an integer of 2 or more) by using five secure computation server apparatuses connected to each other via a network, the secure computation method comprising:
causing an individual one of the secure computation server apparatuses to perform reshare to an arithmetic share from the logic shares without communicating with the other secure computation server apparatuses by setting a sub-share not held thereby to zero;
causing the individual one of the secure computation server apparatuses to perform a secure computation with communications by using the arithmetic share acquired by the reshare, to acquire an arithmetic share from the logic share through a bit conversion; and
causing the individual one of the secure computation server apparatuses to compare received values with each other, which are received from at least three of the secure computation server apparatuses and which are supposed to be a same value, and adopt the received values, that are same at least two received values as an accurate value, so as to verify the received values acquired in the secure computation with communications.

7. The secure computation method according to claim 6; wherein the individual one of the secure computation server apparatuses performs:
resharing, as arithmetic shares, temporary variables computed from sub-shares in the logic shares;
comparing received values with each other, which are received from at least three of the secure computation server apparatuses and which are supposed to be a same value, and adopting at least two of the received values, the two received values being the same value, as an accurate value, so as to verify the received values of the arithmetic shares of the reshared temporary variables; and
performing, by using the arithmetic shares of the reshared temporary variables and the arithmetic share computed without communications, a secure computation to obtain an arithmetic share from the logic share through a bit conversion.

8. The secure computation method according to claim 7;
wherein the temporary variables are computed from sub-shares in the logic share commonly held by three of the five secure computation server apparatuses;
wherein arithmetic shares determinably generated from the temporary variables commonly computed by the three secure computation server apparatuses are reshared; and
wherein, regarding the arithmetic shares received from the three secure computation server apparatuses, the received values that are same at least two or more received values is adopted as an accurate value.

9. The secure computation method according to claim 6; wherein it is determined that the received values are each an accurate value by determining that hash values of the received values are same.

10. A non-transient computer readable medium storing a secure computation program, causing at least five secure computation server apparatuses connected to each other via a network to perform a secure computation on values held in a secret sharing manner and causing five secure computation server apparatuses connected to each other via a network to perform a bit conversion from logic shares on a residue class ring of modulo 2 that are held in a secret sharing manner to arithmetic shares on a residue class ring of modulo n (n=2^{m}; m is an integer of 2 or more), an individual one of the secure computation server apparatuses performing:
resharing to an arithmetic share from the logic shares without communicating with the other secure computation server apparatuses by setting a sub-share not held thereby to zero;
a secure computation with communications by using the arithmetic share acquired by the reshare, to acquire an arithmetic share from the logic share through a bit conversion; and
comparing received values with each other, which are received from at least three of the secure computation server apparatuses and which are supposed to be a same value, and adopting the received values that are same at least two received values as an accurate value, so as to verify the received values acquired in the secure computation with communications.

11. The secure computation server apparatus according to claim 5, further includes a reshare part that shares, as arithmetic shares, temporary variables computed from sub-shares in the logic shares;
wherein the comparison and verification part verifies received values of the arithmetic shares of the temporary variables shared by the reshare part; and
wherein, by using the arithmetic shares of the temporary variables shared by the reshare part and the arithmetic share obtained by the local reshare part, the secure computation part performs a secure computation to obtain an arithmetic share from the logic share through a bit conversion.

12. The secure computation server apparatus according to claim 11;
wherein the temporary variables are computed from sub-shares in the logic share commonly held by three of the five secure computation server apparatuses;
wherein the reshare part shares arithmetic shares determinably generated from the temporary variables commonly computed by the three secure computation server apparatuses; and
wherein, regarding the arithmetic shares received from the three secure computation server apparatuses, the comparison and verification part adopts the received values that are same at least two or more received values as an accurate value.

13. The secure computation server apparatus according to claim 5; wherein the comparison and verification part determines that the received values are each an accurate value by determining that hash values of the received values are same.

14. The non-transient computer readable medium storing the secure computation program according to claim 10, causing the individual one of the secure computation server apparatuses to perform:
resharing, as arithmetic shares, temporary variables computed from sub-shares in the logic shares;
comparing received values with each other, which are received from at least three of the secure computation server apparatuses and which are supposed to be a same value, and adopting at least two of the received values, the two received values being the same value, as an accurate value, so as to verify the received values of the arithmetic shares of the reshared temporary variables; and
performing, by using the arithmetic shares of the reshared temporary variables and the arithmetic share computed without communications, a secure computation to obtain an arithmetic share from the logic share through a bit conversion.

15. The non-transient computer readable medium storing the secure computation program according to claim 14;
wherein the temporary variables are computed from sub-shares in the logic share commonly held by three of the five secure computation server apparatuses;
wherein arithmetic shares determinably generated from the temporary variables commonly computed by the three secure computation server apparatuses are reshared; and
wherein, regarding the arithmetic shares received from the three secure computation server apparatuses, the received values that are same at least two or more received values is adopted as an accurate value.

16. The non-transient computer readable medium storing the secure computation program according to claim 10; wherein it is determined that the received values are each an accurate value by determining that hash values of the received values are same.
